(19) United States
(12) Patent Application Publication
(10) Pub. No.: US 2015/0136675 A1
(43) Pub. Date: May 21, 2015

(54) OIL-WATER SEPARATING STRUCTURE AND OIL-WATER SEPARATING SYSTEM USING THE SAME

(71) Applicant: WEN-PIN CHEN, Miaoli County (TW)

(72) Inventor: WEN-PIN CHEN, Miaoli County (TW)

(21) Appl. No.: 14/541,888

(22) Filed: Nov. 14, 2014

(30) Foreign Application Priority Data
Nov. 15, 2013 (TW) 102141639

(51) Int. Cl. C02F 1/40

(52) U.S. Cl. CPC C02F 1/40; C02F 2103/34
USPC 210/196; 210/416.5; 210/242.3

(57) ABSTRACT

An oil and water separating structure is provided. The oil and water separating structure mainly uses a pump to drive a fluid to form a jet flow in high flow velocity so as to produce a suction force. Oil floating on the water surface will be sucked into a tube and discharged along with the fluid. A mixed fluid discharged contains a high proportion of oil, so it is convenient to deal with the discharged oil. The oil and water separating structure can effectively separate oil from water.

### BACKGROUND OF THE INVENTION

1. Field of the Invention

The present invention relates to a separating structure, and more particularly to an oil and water separating structure and oil and water separating system using the same.

2. Description of the Prior Art

It is ordinary for working machines to use lubricating oil or cutting oil in works to keep the working machines to work smoothly. Nevertheless, the cutting oil is primarily composed of cooling water and oil. When the cutting oil is processed in recycling, impurities are needed to be filtered and the oil and the water are needed to be separated. A common method of separating the water and the oil in prior art is to use a filtering cotton to absorb the oil on fluid surface and then recycle the water to use. However, the filtering cotton not only absorbs the cutting oil but also absorbs a large amount of the water. An efficiency of separating the oil and the water is low. The filtering cotton is also a problem after using and increases cost. Furthermore, some devices for separating the oil and the water are provided, for example, a structure driven by an electrical motor. The oil and the water can be separated and reused again, but the structure is complicated, has large volume and costs lots of power, so a performance of the device in prior art is limited and it costs too much.

The present invention has arisen to mitigate and/or obviate the afore-described disadvantages.

### SUMMARY OF THE INVENTION

The primary object of the present invention is to provide an oil and water separating structure which works with a high efficiency.

To achieve the above object, an oil and water separating structure is provided, for assembling to a pump to use. Wherein the pump is at least partly disposed in a first receiving space of a first reservoir including a mixed fluid of oil and water. The pump can be used for transporting the fluid in the first reservoir to outside. Wherein the oil and water separating structure includes: a transporting device, including a transporting conduit mechanism. An end of the transporting conduit mechanism is provided with an inlet port for communicatingly connecting with the pump, and the other end is provided with an outlet port for disposing below a fluid surface so that the pump drives the fluid in the first reservoir to flow into the inlet port and flow out from the outlet port. The fluid with the oil in the first reservoir is jetted out of the fluid surface.

To achieve the above object, an oil and water separating system is further provided, including an oil and water separating structure as described above, further including: a first reservoir, having a first receiving space; a pump, including an entry tube and an exit tube, the entry tube extending into the first receiving space of the first reservoir, the exit tube communicated with the inlet port of the transporting conduit mechanism, the pump driving the fluid contained in the first reservoir to be sucked into the pump via the entry tube and be transmitted to the transporting conduit mechanism via the exit tube; a second reservoir, disposed outside the first reservoir, having a second receiving space, for receiving the fluid with the oil coming from the first reservoir.

As a result, when the fluid passes through the outlet port, the pump drives the fluid to form a flow jet and jet out with high velocity. The oil floating on the fluid surface is discharged from the reservoir with the flow jet when the fluid is jetted out, and a work of separating the oil and the water is finished.

### BRIEF DESCRIPTION OF THE DRAWINGS

FIG. 1 is a cross-sectional drawing of a preferred embodiment of the present invention;

FIG. 2 is a partial cross-sectional drawing of the preferred embodiment of the present invention;

FIGS. 3 and 4 are perspective drawings of the preferred embodiment of the present invention in use;

FIG. 5 is a perspective drawing of a second embodiment of the present invention in use;

FIG. 6 is a perspective drawing of a third embodiment of the present invention in use;

FIG. 7 is a partial perspective drawing of FIG. 6.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

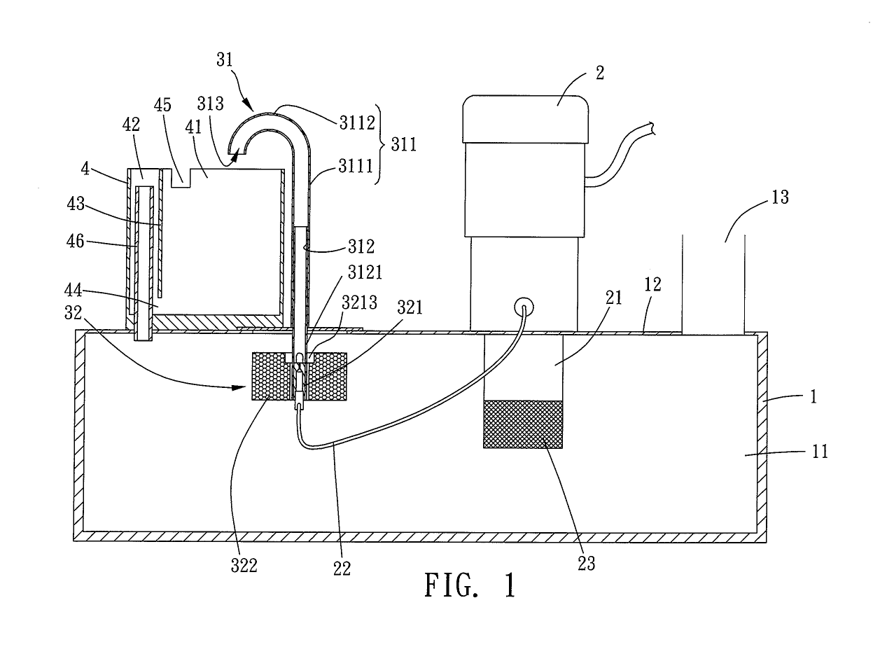

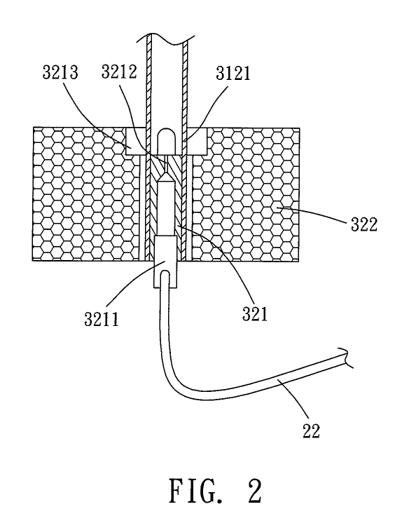

Referring to FIGS. 1-2, an oil and water separating system in accordance with a preferred embodiment of the present invention includes a first reservoir 1, a pump 2, an oil and water separating structure and a second reservoir 4.

The first reservoir 1 has a first receiving space 11. The first reservoir 1 is provided with a base 12 on a top thereof. The first reservoir 1 further includes an entrance 13, and the entrance 13 is for cutting oil (or other fluids) of a working machine to flow therein.

The pump 2 is disposed on the base 12. The pump 2 includes an entry tube 21 and an exit tube 22. The entry tube 21 extends into the first receiving space 11 of the first reservoir 1 and provided with a filter member 23 (the filter member can be a filtering net or other filtering structures).

The oil and water separating structure includes a pipe assembly 31 and a transporting device 32. The pipe assembly 31 includes a first pipe 311 and a second pipe 312. An end of the first pipe 311 is formed with a discharge aperture 313, and the other end and the second pipe 312 are communicatingly connected with and slidable relative to each other. Specifically, the first pipe 311 includes a straight portion 3111 and a bending portion 3112. The second pipe 312 is slidably disposed inside the straight portion 3111. A distal end of the bending portion 3112 is formed with the discharge aperture 313; a portion of the second pipe 312 extending downwards and out of the first pipe 311 is a connecting pipe 3121. The connecting pipe 3121 is formed with a plurality of flow holes so that the fluids from outside can flow thereinto; the first pipe 311 is disposed on the base 12. The connecting pipe 3121 of the second pipe 312 penetrates through the base 12 and extends into the first reservoir 1. The transporting device 32 is disposed on the second pipe 312. The transporting device 32 includes a transporting conduit mechanism 321 and a floating structure 322 floatable on a fluid surface. The transporting conduit mechanism 321 is disposed inside the connecting pipe 3121 of the second pipe 312. An end of the transporting conduit mechanism 321 neighboring to an exit of the connecting pipe 3121 is provided with an inlet port 3211 for communicatingly connecting with the pump 2 (the exit tube 22 is communicated with the inlet port 3211 of the transporting conduit mechanism 321), and the other end is provided with an outlet port 3212. Wherein a diameter of the transporting conduit mechanism 321 is taperingly reduced. The inlet port 3211 is greater than the outlet port 3212 in diameter. The outlet port 3212 is formed with an elongated shape. The floating structure 322 can be a floating cylinder, a floating ball or other structures floatable on the fluid surface. The floating structure 322 is connected with the connecting pipe 3121 of the second pipe 312. The connecting pipe 3121 extends into the floating structure 322. The floating structure 322 floats on the fluid surface in the first receiving space 11, and the floating structure 322 is floatably moved by buoyancy of the fluid according to change in level of the fluid surface and drives the second pipe 312 to slide relative to the first pipe 311 up and down. The floating structure 322 is formed with a receiving slot 3213 on a surface neighboring to the flow hole. The receiving slot 3213 is for receiving the fluid so that the fluid can flow into the connecting pipe 3121 via the flow hoe of the connecting pipe 3121.

The second reservoir 4 is disposed on the base 12. The second reservoir 4 has a second receiving space 41 and a third receiving space 42, and a top inside the second reservoir 4 is extendingly formed with a block plate 43 downwardly. The block plate 43 separates the second receiving space 41 and the third receiving space 42. A flow channel 44 is formed between the block plate 43 and a bottom of the second reservoir 4. The second receiving space 41 and the third receiving space 42 are communicated with each other through the flow channel 44. The second reservoir 4 is formed with an oil expelling hole 45 neighboring to a top of the second receiving space 41; the discharge aperture 313 corresponds to the second receiving space 41 so that the fluid can flow into the second receiving space 41. In the present embodiment, the discharge aperture 313 is located above the second receiving space 41. The fluid flowing out of the discharge aperture 313 flows into the second receiving space 41 directly via the gravity (in other embodiments, the first pipe can communicatingly extend into the second reservoir directly, and the fluid flowing out of the discharge aperture can also flow into the second receiving space directly); the third receiving space 42 and the first receiving space 11 are communicated with each other. Specifically, the second reservoir 4 includes a recycling pipe 46 which is vertically standing. The recycling pipe 46 is disposed in the third receiving space 42 and penetrates through both the second reservoir 4 and the base 12. The recycling pipe 46 is at least high above the flow channel 44. The recycling pipe 46 is communicated with the third receiving space 42 and the first receiving space 11.

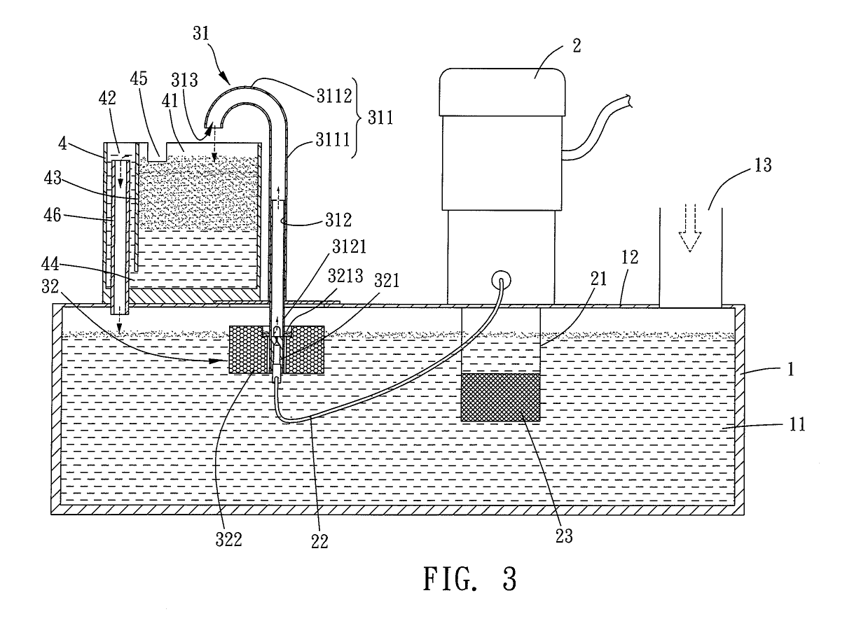

In practical use, please refer to FIGS. 3 and 4, the pump 2 drives the fluid contained in the first reservoir 1 to be sucked into the pump 2 via the entry tube 21 and be transmitted to the transporting conduit mechanism 321 via the exit tube 22, and then the pump 2 drives the fluid to flow into the second pipe 312 through the transporting conduit mechanism 321 and flow out through the discharge aperture 313 of the first pipe 311 so that the fluid flows into the second reservoir 4; specifically, the pump 2 can drive the fluid to jet out from the outlet port 3212, and the fluid can pass through the second pipe 312 and the discharge aperture 313 of the first pipe 311 in regular turn and flow into the second reservoir 4. The oil floating on the fluid surface is discharged through the oil expelling hole 45, and a work of separating the oil and the water is finished.

It is noted that when the fluid flows through the outlet port 3212, a flow velocity of the fluid increases because a diameter of the outlet port 3212 decreases, and a pressure inside the pipe correspondingly decreases (Bernoulli's principle). An internal of the connecting pipe 3121 is formed with a low-pressure suction force, and the fluid is sucked into the connecting pipe 3121 from outside through the flow hole (the fluid inside the receiving slot 3213 or adjacent to the flow hole). The fluid from outside is transmitted to the second reservoir 4 along with the fluid inside the pipe; wherein the fluid from outside which is sucked into the pipe through the flow hole is mostly oil pollution and impurities (the floating structure 322 keeps the flow hole of the connecting pipe 3121 to remain at a height adjacent to the fluid surface) so that the fluid flowing into the second reservoir 4 has a high proportion of the oil. And the second reservoir 4 is convenient for a work of oil expelling. The fluid flowing into the second receiving space 41 of the second reservoir 4, and the water (having a larger specific density than that of the oil) is located below and can flow into the third receiving space 42 via the flow channel 44 and then flow into the first reservoir 1 via the recycling pipe 46.

The present invention uses the pump 2 to drive the fluid to form a jet flow in high flow velocity so as to produce the suction force. The oil floating on the fluid surface is sucked into the pump 2 and discharged into the second reservoir 4. The fluid discharged contains the high proportion of the oil, so it is convenient to deal with the discharged oil. Compared with a prior art which takes lots of time and power, the present invention has a better efficiency in discharging the oil and saves energy. A normal electrical motor is applied and other complicated structures are unnecessary, so it saves cost. Furthermore, the present invention has a simple structure, and it costs low in manufacturing and maintenance. It can be applied in working places with large or small space. A loud noise is avoided in using. It improves disadvantages of the oil and water separating structure of the prior art and has industry value.

It is noted that a sliding structure is designed between the first pipe 311 and the second pipe 312, and when the height of the fluid surface in the first reservoir 1 is changed, the floating structure 322 floats with the height of the fluid surface. The second pipe 312 is driven to slide relative to the first pipe 311, and the flow hole of the connecting pipe 3121 can remain at the height of the fluid surface. It is convenient for a work of sucking the fluid on the fluid surface. The present invention can be applied at different heights of the fluid surface, and it is automatically adjusted with the height of the fluid surface. It is convenient for using.

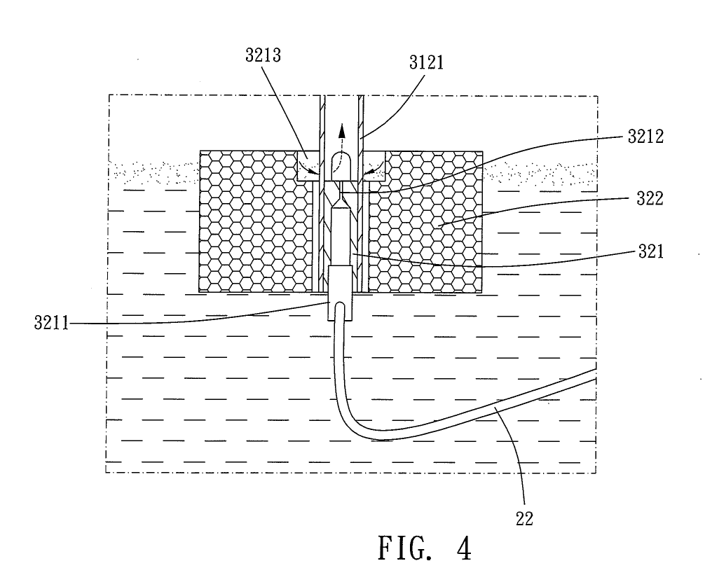

Furthermore, in other embodiments, a transporting conduit mechanism can be applied directly and individually. An oil and water separating structure in a second embodiment of the present invention (please refer to FIG. 5), for assembling to the pump 2 to use. The pump 2 is disposed in a reservoir including a mixed fluid of oil and water. The pump 2 can be used for transporting the fluid in the reservoir to outside. Wherein the oil and water separating structure includes a transporting device 32. The transporting device 32 includes a transporting conduit mechanism 321. The transporting conduit mechanism 321 is disposed in the reservoir and inclined with an angle. An end of the transporting conduit mechanism 321 is provided with an inlet port for communicatingly connecting with the pump 2, and the other end is provided with an outlet port for disposing below the fluid surface. The pump 2 drives the fluid in the reservoir to flow into the inlet port of the transporting conduit mechanism 321 and flow out from the outlet port so that the fluid with the oil in the reservoir is jetted out of the fluid surface; the oil floating on the fluid surface is also discharged from the reservoir by a jet flow, and the oil is discharged with the fluid and falls into another reservoir. It also achieves a function of separating the oil and the water.

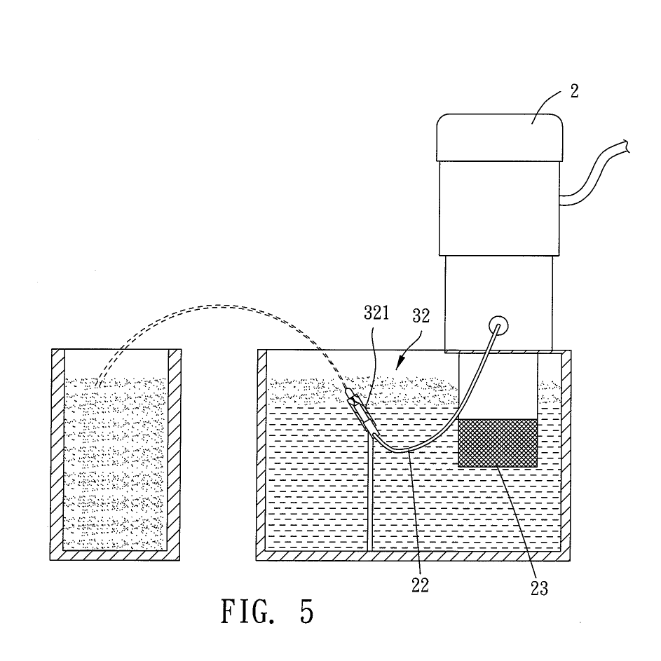

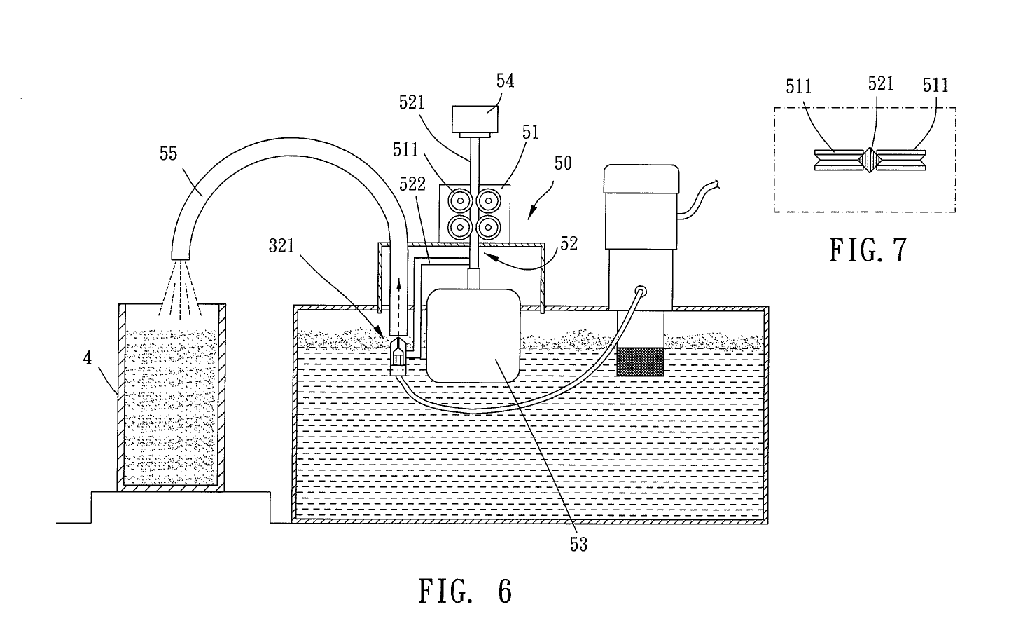

Compared with the embodiment as shown in FIG. 5, a third embodiment as shown in FIGS. 6 and 7, the transporting device further includes a position limiting mechanism 50. At least part of the position limiting mechanism 50 is located in the first receiving space of the first reservoir 1 and connected with the transporting conduit mechanism 321. The position limiting mechanism 50 can limit a position of the transporting conduit mechanism 321. The position limiting mechanism 50 includes a sliding base 51 disposed on a top of the first reservoir 1, a sliding rack 52 slidably disposed on the sliding base 51 and a floating structure 53 connected with an end of the sliding rack 52. The transporting conduit mechanism 321 is connected with the sliding rack 52 and driven by the sliding rack 52. The floating structure 53 is floatable on a fluid surface in the first receiving space. The floating structure 53 is floatably moved by buoyancy of the fluid according to change in level of the fluid surface and drives the sliding rack 52 to slide relative to the sliding base 51 to position the outlet port at a predetermined distance below the fluid surface.

Specifically, the sliding base 51 is provided with a plurality of sliding wheels 511. The sliding rack 52 is provided with a moving rail 521 slidably disposed between the sliding wheels 511 and an arm member 522 laterally connected with the moving rail 521, and the transporting conduit mechanism 321 is connected with an end of the arm member 522. Wherein the moving rail 521 is preferably provided with a weight structure 54 on an end opposite to the floating structure 53 for selectively increasing or reducing weight. The weight structure 54 is such as a weight block and for adjusting a position of the floating structure 53 relative to the fluid surface. The outlet port of the transporting conduit mechanism 321 corresponds to an external pipe 55 communicating with a second reservoir 4, and the fluid with the oil jetted out from the first reservoir 1 is jetted into the external pipe 55 and guided to the second reservoir 4. It is noted that a structure of the second reservoir 4 in the present embodiment can be replaced with the structures as shown in FIGS. 1 and 3.

While we have shown and described various embodiments in accordance with the present invention, it should be clear to those skilled in the art that further embodiments may be made without departing from the scope of the present invention.

What is claimed is:

1. An oil and water separating structure, for assembling to a pump to use, wherein the pump is disposed at least partly in a first receiving space of a first reservoir containing a mixed fluid of oil and water, the pump is used for transporting the fluid from the first reservoir to outside, the oil and water separating structure comprising:
a transporting device, including a transporting conduit mechanism, an end of the transporting conduit mechanism provided with an inlet port for being communicatingly connected with the pump, the other end of the transporting conduit mechanism provided with an outlet port for being disposed below a fluid surface, the pump driving the fluid to flow into the inlet port and flow out from the outlet port, the fluid with the oil in the first reservoir jetted out of the fluid surface.

2. The oil and water separating structure as claimed in claim 1, wherein the transporting device further includes a position limiting mechanism, at least part of the position limiting mechanism is located in the first receiving space and connected with the transporting conduit mechanism, and the position limiting mechanism is for limiting positions of the transporting conduit mechanism.

3. The oil and water separating structure as claimed in claim 2, wherein the position limiting mechanism includes a sliding base disposed on a top of the first reservoir, a sliding rack slidingly disposed on the sliding base and a floating structure connected to an end of the sliding rack, the transporting conduit mechanism is connected to the sliding rack and co-movable with the sliding rack, the floating structure is floatable on the fluid surface in the first receiving space, and the floating structure is floatably moved by buoyancy of the fluid according to change in level of the fluid surface and drives the sliding rack to slide relative to the sliding base to position the outlet port in a predetermined distance below the fluid surface.

4. The oil and water separating structure as claimed in claim 3, wherein the sliding base is provided with a plurality of sliding wheels, the sliding rack is provided with a moving rail slidingly disposed between the sliding wheels and an arm member laterally connected with the moving rail, and the transporting conduit mechanism is connected with an end of the arm member.

5. The oil and water separating structure as claimed in claim 4, wherein the moving rail is provided with a weight structure on an end opposite to the floating structure for selectively increasing or reducing weight.

6. An oil and water separating system, including an oil and water separating structure as described in claim 1, further comprising:
a first reservoir, having a first receiving space;
a pump, including an entry tube and an exit tube, the entry tube extending into the first receiving space of the first reservoir, the exit tube communicating with the inlet port of the transporting conduit mechanism, the pump driving the fluid contained in the first reservoir to be sucked into the pump via the entry tube and be transmitted to the transporting conduit mechanism via the exit tube;
a second reservoir, disposed outside the first reservoir, having a second receiving space, for receiving the fluid with oil coming from the first reservoir.

7. The oil and water separating system as claimed in claim 6, wherein the outlet port of the transporting conduit mechanism corresponds to an external pipe communicating with the second reservoir, and the fluid with the oil jetted out from the first reservoir is jetted into the external pipe and guided into the second reservoir.

8. The oil and water separating system as claimed in claim 7, wherein the second reservoir has a third receiving space, the second receiving space and the third receiving space are communicated with each other through a flow channel, and the third receiving space and the first receiving space are communicated with each other.

9. The oil and water separating system as claimed in claim 8, wherein the first reservoir is provided with a base on a top thereof, the second reservoir is disposed on the base, the second reservoir includes a recycling pipe, and the recycling pipe is communicated with the third receiving space and the first receiving space.

10. The oil and water separating system as claimed in claim 9, wherein the second reservoir is provided with a block plate therewithin, the block plate separates the second and third receiving spaces, the flow channel is formed between the block plate and a bottom of the second reservoir, the recycling pipe is disposed in the third receiving space, and the recycling pipe is at least high above the flow channel.
